(19) United States
(12) Patent Application Publication
(10) Pub. No.: US 2016/0211621 A1
(43) Pub. Date: Jul. 21, 2016

(54) SHIELD STRUCTURE, SHIELD SHELL AND METHOD OF MANUFACTURING SHIELD CONNECTOR WITH ELECTRIC WIRE

(71) Applicant: YAZAKI CORPORATION, Tokyo (JP)

(72) Inventors: Yoshitaka Ohkubo, Shizuoka (JP); Miki Nakamura, Shizuoka (JP); Takeshi Innan, Shizuoka (JP)

(21) Appl. No.: 15/079,572

(22) Filed: Mar. 24, 2016

Related U.S. Application Data
(63) Continuation of application No. PCT/JP2014/078406, filed on Oct. 24, 2014.

(30) Foreign Application Priority Data
Oct. 25, 2013 (JP) 2013-222608

(51) Int. Cl. H01R 13/6596; H01R 43/048

(52) U.S. Cl. CPC H01R 13/6596; H01R 43/048

(57) ABSTRACT

A shield structure includes a shield member which is formed into a hollow tubular shape and a shield shell to which a leading end in the longitudinal direction of the shield member is attached. In the shield structure, the shield shell has a plate-like shell main body through which a through hole is bored, and a plurality of shell tightening pieces which are extended from an outer edge of the shell main body, the shell main body is so arranged that the leading end in the longitudinal direction of the shield member surrounds the through hole, and the leading end in the longitudinal direction of the shield member is clamped by the shell main body and the shell tightening pieces which are bent to the shell main body.

### CROSS REFERENCE TO RELATED APPLICATIONS

This application is a continuation of PCT application No. PCT/JP2014/078406, which was filed on Oct. 24, 2014 based on Japanese Patent Application (No. 2013-222608) filed on Oct. 25, 2013, the contents of which are incorporated herein by reference.

### BACKGROUND OF THE INVENTION

1. Technical Field

The present invention relates to a shield structure, a shield shell and a method of manufacturing a shield connector with electric wire, and particularly to the structure of a shield shell.

2. Background Art

In JP-A-2010-268562, a shield electric wire fixing structure to attach a braiding of a shield electric wire to a shield shell of a shield connector is described. In the shield electric wire fixing structure of the JP-A-2010-268562, while a braiding 22 is placed on the outer periphery of a small diameter part 41 of a shield shell 40, the braiding 22 is attached to the shield shell 40 by tightening a shield ring 30 to the small diameter part 41.

The small diameter part 41 of the shield shell 40 described in the JP-A-2010-268562 has a hollow cylindrical shape which is extended from a body part 42 of the shield shell 40 in which an inner holder 50 is accommodated. The shield shell 40 including the small diameter part 41 and the body part 42 is molded by being twist-pressed. Further, it is described in a JP-A-2013-115072 that a shield shell is manufactured by die-casting.

### SUMMARY OF THE INVENTION

However, for the structure described in the JP-A-2010-268562 to attach the braiding 22 to the shield shell 40 by tightening the shield ring 30, the number of components of the shield connector increases. Therefore, a shield structure is demanded to reduce the component number of the shield connector.

Further, when the shield shell in the structure described in the JP-A-2010-268562 is manufactured by twist-pressing or die-casting, the manufacturing cost increases because of the complexity of the manufacturing methods.

Therefore, a shield shell is demanded for which the shield connector with electric wire can be manufactured by a simpler manufacturing method.

The present invention is made in view of the above circumstances, and the object of the present invention is to provide a shield structure, a shield shell used in the shield structure, and a method of manufacturing a shield connector with electric wire so that while the component number of the shield connector is reduced, the shield connector with electric wire can be manufactured by a simpler manufacturing method.

To achieve the previously described object, the shield structure according to the present invention is characterized by the following (1) to (7).

(1) A shield structure, including

a shield member which is formed into a hollow tubular shape, and a shield shell to which the leading end in the longitudinal direction of the shield member is attached, wherein

the shield shell has a plate-like shell main body through which a through hole is bored, and a plurality of shell tightening pieces which are extended from the outer edge of the shell main body, the shell main body is so arranged that the leading end in the longitudinal direction of the shield member surrounds the through hole, and the leading end in the longitudinal direction of the shield member is clamped by the shell main body and the shell tightening pieces which are bent to the shell main body.

(2) The shield structure according to (1), wherein the shell tightening pieces are provided equidistantly along the outer edge of the shell main body.

(3) The shield structure according to (1) or (2), wherein

the shell tightening pieces are provided with protrusions on surfaces which face the shell main body when the shell tightening pieces are bent to the shell main body.

(4) The shield structure according to (3), wherein

the shell tightening pieces are formed with concaves at positions corresponding to the protrusions on surfaces opposite to the surfaces where the protrusions are provided.

(5) The shield structure according to any one of (1) to (4), wherein

the shell tightening pieces which are bent to the shell main body extend toward a center of the through hole.

(6) The shield structure according to any one of (1) to (5), wherein

a shape of the through hole of the shell main body and a shape that defines the outer edge of the shell main body are round, and a center of the through hole corresponds to a center of the shape of the outer edge of the shell main body.

(7) The shield structure according to any one of (1) to (5), wherein

a shape of the through hole of the shell main body and a shape that defines the outer edge of the shell main body are rectangles that are similar to each other, and a center of the through hole corresponds to a center of the shape of the outer edge of the shell main body.

According to the shield structure of the constitution of the above (1), upon attaching the shield member to the shield shell, a shield ring used traditionally becomes needless. Therefore, the component number of the shield connector can be reduced.

According to the shield structure of the constitution of the above (2), the shell main body and the shell tightening pieces can grip the leading end of the shield member equidistantly along the circumferential direction.

According to the shield structure of the constitution of the above (3), the leading end is clamped by the shell main body and the protrusions by a big pressure force.

According to the shield structure of the constitution of the above (4), by forming the protrusions at the time of bend-pressing, the shell tightening pieces can be formed with the protrusions easily.

According to the shield structure of the constitution of the above (5), a range that is wider than the leading end of the shield member can be gripped by the shell main body and the shell tightening pieces.

According to the shield structure of the constitution of the above (6), the shield member can be attached to the center of the shell main body.

According to the shield structure of the constitution of the above (7), the shield member can be attached to the center of the shell main body.

To achieve the previously described object, the shield shell according to the present invention is characterized by the following (8) to (9).

(8) A shield shell, including

a plate-like shell main body through which a through hole is bored, and

a plurality of shell tightening pieces which are extended from the outer edge of the shell main body, wherein

the leading end in the longitudinal direction of a shield member which is arranged to surround the through hole may be clamped by the shell main body and the shell tightening pieces which are bent to the shell main body.

(9) The shield shell according to (8), wherein an angle between a plane including the shell main body and a direction in which the shell tightening pieces are extended is an acute angle.

According to the shield shell of the constitution of the above (8), upon attaching the shield member to the shield shell, a shield ring used traditionally becomes needless. Therefore, the component number of the shield connector can be reduced.

According to the shield shell of the constitution of the above (9), arranging the leading end to conform to the shape of the through hole can be implemented by a simple operation.

To achieve the previously described object, the method of manufacturing a shield connector with electric wire according to the present invention is characterized by the following (10).

(10) A method of manufacturing a shield connector with electric wire including a pressing step of forming a shield shell which has a plate-like shell main body through which a through hole is bored, and a plurality of shell tightening pieces which are extended from the outer edge of the shell main body by pressing a metal plate, an arranging step of arranging the leading end in the longitudinal direction of a shield member which is formed into a hollow tubular shape to the shell main body to surround the through hole, and a bending step of clamping the leading end in the longitudinal direction of the shield member with the shell main body and the shell tightening pieces by bending the shell tightening pieces to the shell main body.

According to the manufacturing method of the shield connector with electric wire of the constitution of the above (10), the shield shell has a shape that is molded only by punch-pressing and bend-pressing. Therefore, the manufacturing method can be simplified in comparison with a traditional manufacturing method of manufacturing a shield shell by twist-pressing or die-casting.

According to the present invention, the component number of the shield connector is reduced and the shield connector with electric wire can be manufactured by a simpler manufacturing method.

The present invention has been briefly described above. Further, details of the invention will become more apparent after embodiments of the invention described below (hereinafter referred to as “embodiments”) are read with reference to the accompanying figures.

### BRIEF DESCRIPTION OF THE DRAWINGS

FIG. 1 is an exploded perspective view of a shield connector with electric wire and a device side case of the first embodiment of the present invention.

FIG. 2 is a perspective view in which the shield connector with electric wire of the first embodiment of the present invention is attached to the device side case.

FIGS. 3A to 3C are figures to describe the shape of a shield shell of the first embodiment of the present invention, in which FIG. 3A is a front view, FIG. 3B is an A-A line sectional view of FIG. 3A, and FIG. 3C is a perspective view.

FIGS. 4A to 4C are figures to describe the shape of a braiding of the first embodiment of the present invention, in which FIG. 4A is a front view, FIG. 4B is an A-B line sectional view of FIG. 4A, and FIG. 4C is a perspective view.

FIGS. 5A to 5D are figures to describe an operation of attaching the braiding to the shield shell of the first embodiment of the present invention, in which FIGS. 5A to 5D are sectional views to respectively describe one step of the operation.

FIGS. 6A and 6B are perspective views of the shield connector with electric wire of the first embodiment of the present invention, in which FIG. 6A is a perspective view watched from the front side of the shield connector with a electric wire, and FIG. 6B is a perspective view watched from the rear side of the shield connector with a electric wire.

FIG. 7 is an enlarged sectional view of a main part (shell tightening piece) in the shield shell of the first embodiment of the present invention.

FIG. 8 is an enlarged figure of a C part of FIG. 6B.

FIG. 9 is a side view in which the shield connector with electric wire of the first embodiment of the present invention is attached to the device side case.

FIG. 10 is an exploded perspective view of a shield connector with electric wire and a device side case of the second embodiment of the present invention.

FIG. 11 is a perspective view in which the shield connector with electric wire of the second embodiment of the present invention is attached to the device side case.

FIGS. 12A to 12C are figures to describe the shape of a shield shell of the second embodiment of the present invention, in which FIG. 12A is a front view, FIG. 12B is a D-D line sectional view of FIG. 12A, and FIG. 12C is a perspective view.

FIG. 13 is a perspective view to describe the shape of a braiding of the second embodiment of the present invention.

FIGS. 14A to 14B are figures to describe a shield structure of the second embodiment of the present invention, in which FIG. 14A is a perspective view watched from the front side of the shield structure, and FIG. 14B is a perspective view watched from the rear side of the shield structure.

FIG. 15 is an enlarged figure of an E part of FIG. 14B.

### DETAILED DESCRIPTION OF EMBODIMENTS

Specific embodiments of the present invention are described below with reference to the figures. First, the first embodiment of the present invention is described.

### First Embodiment

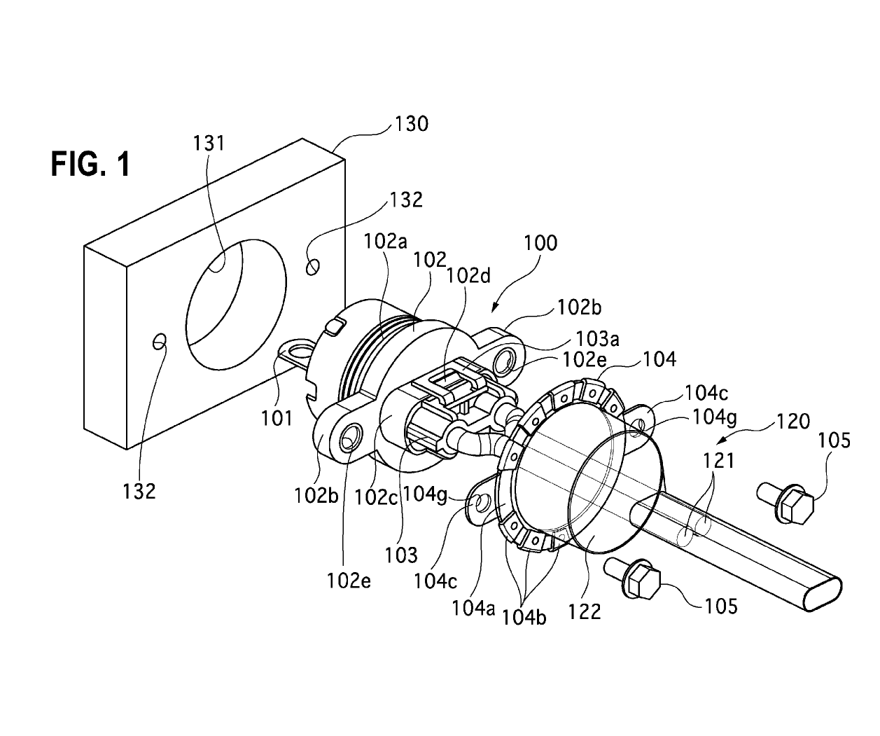

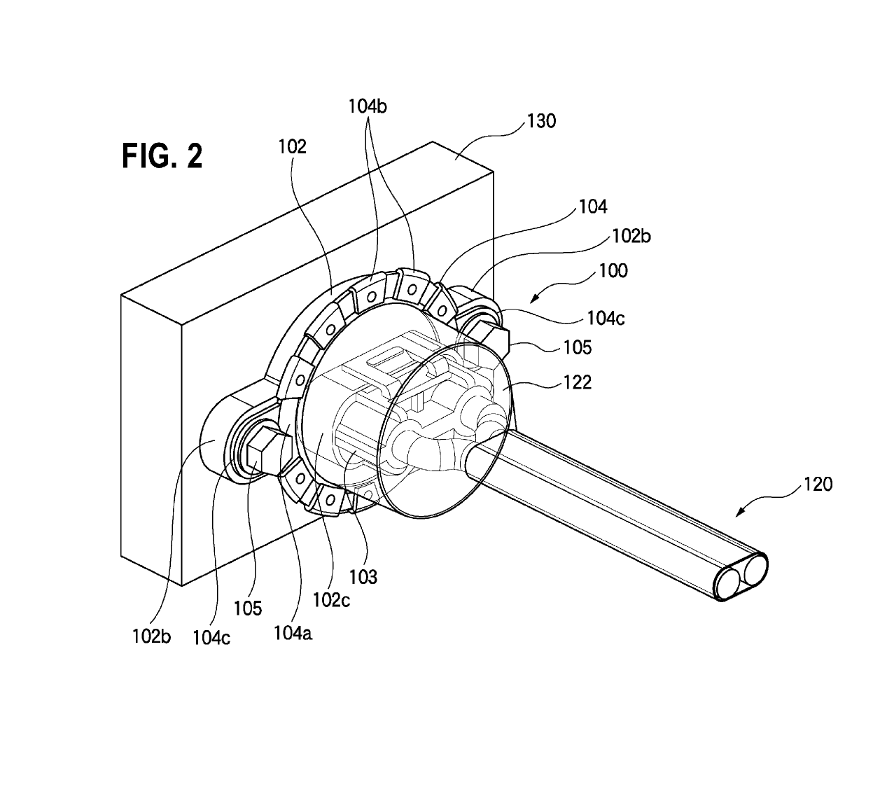

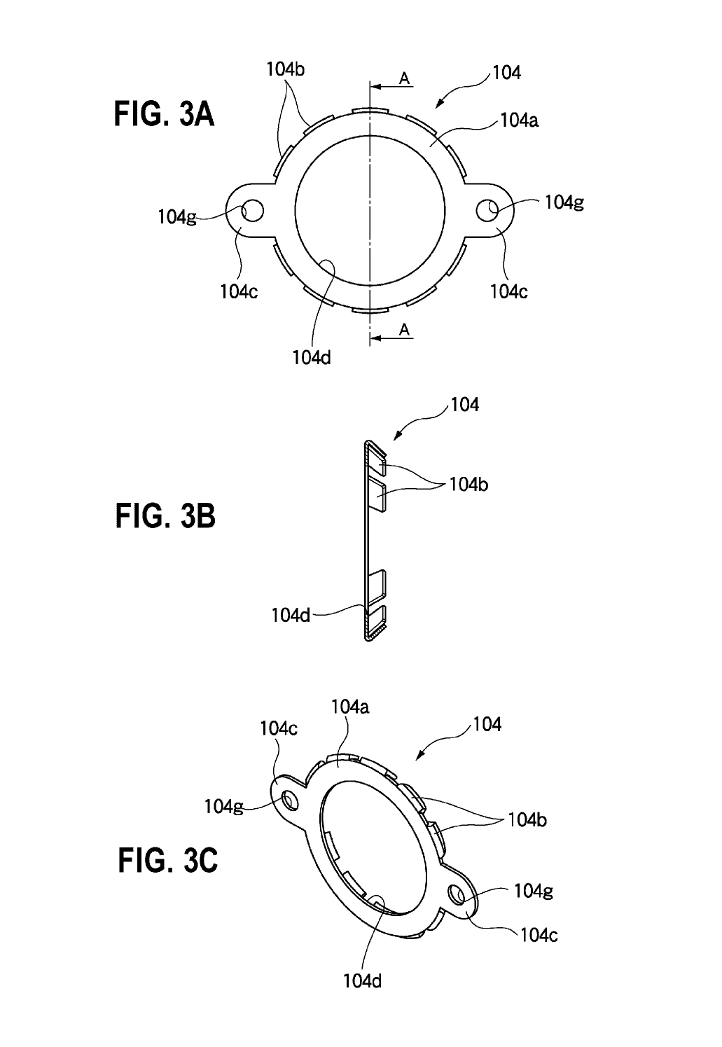

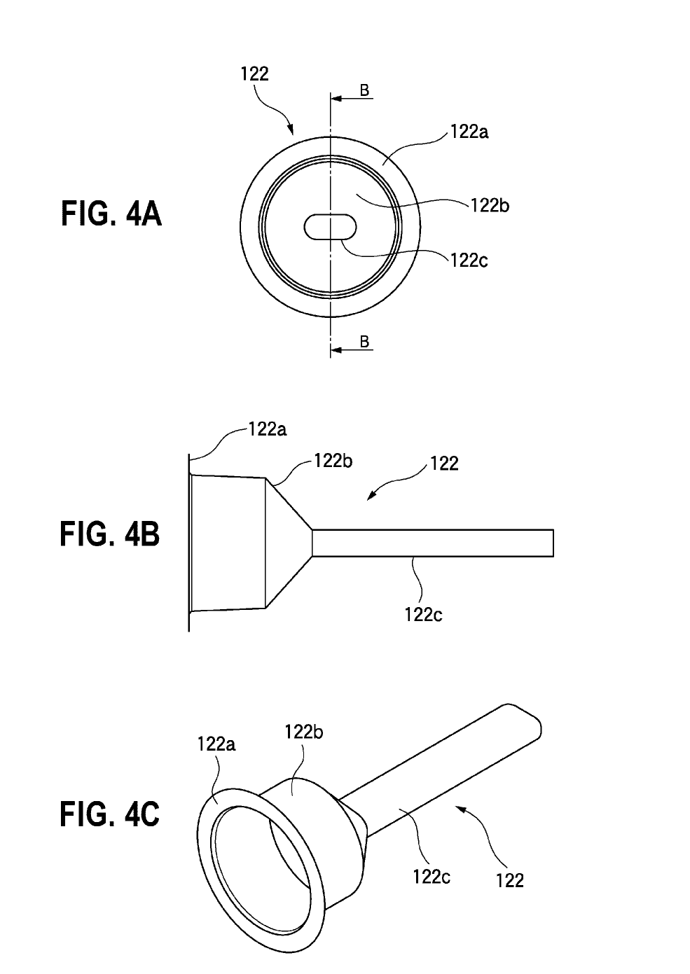

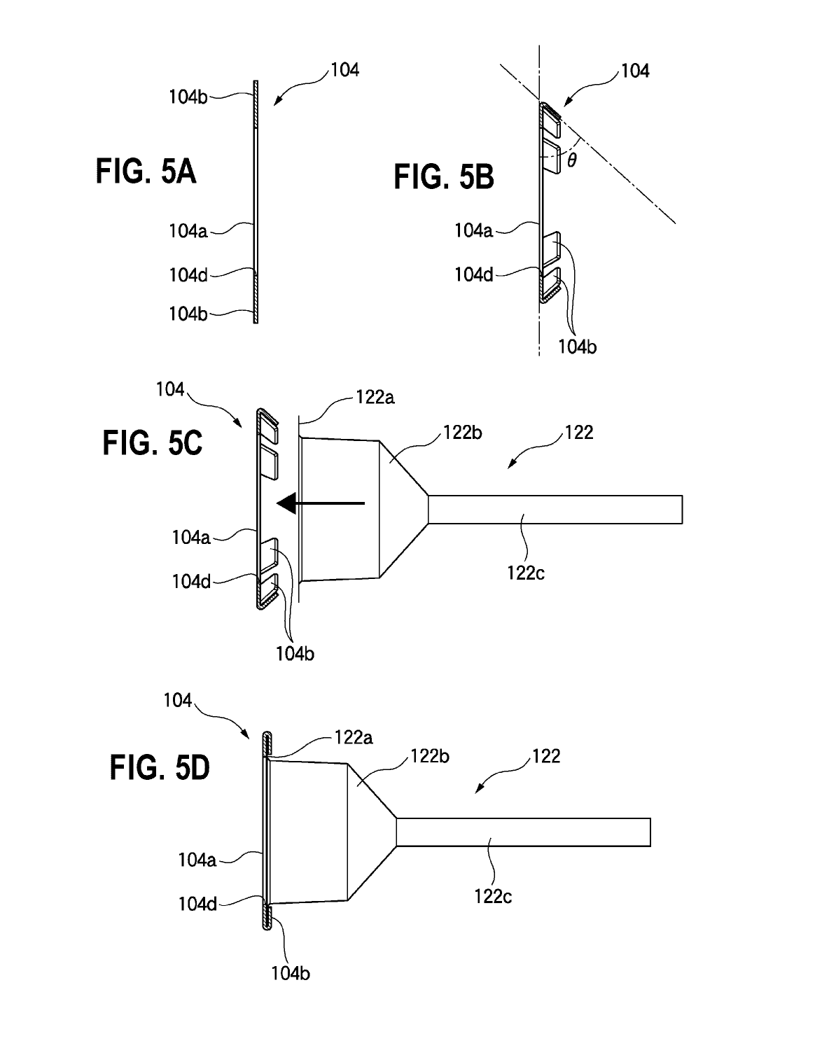

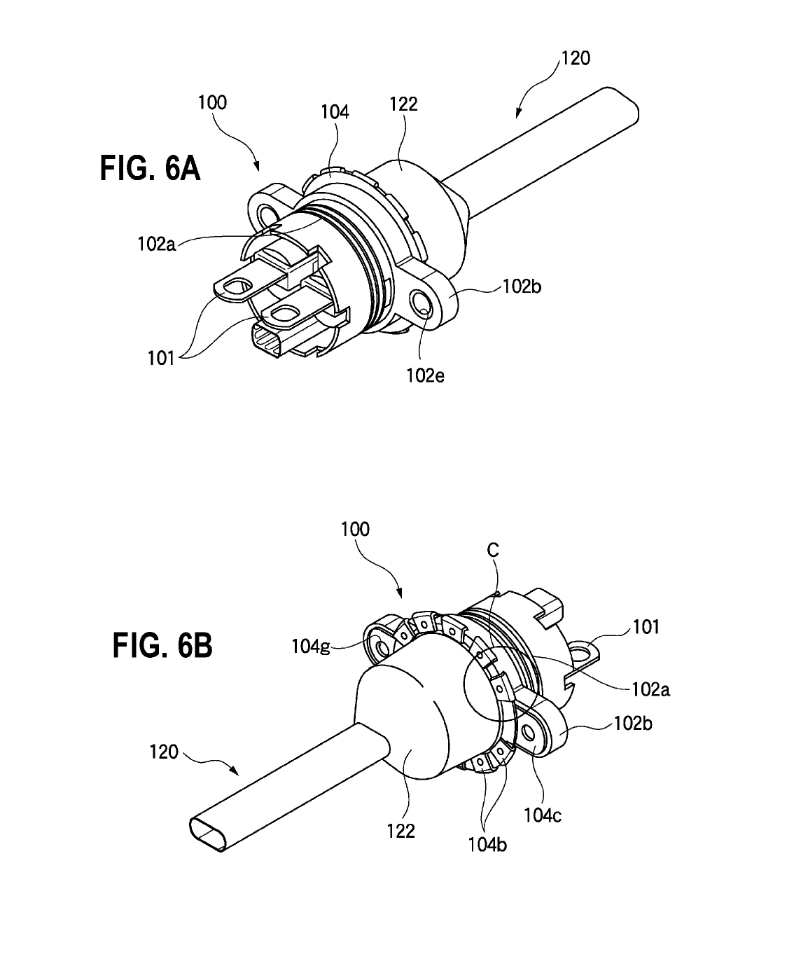

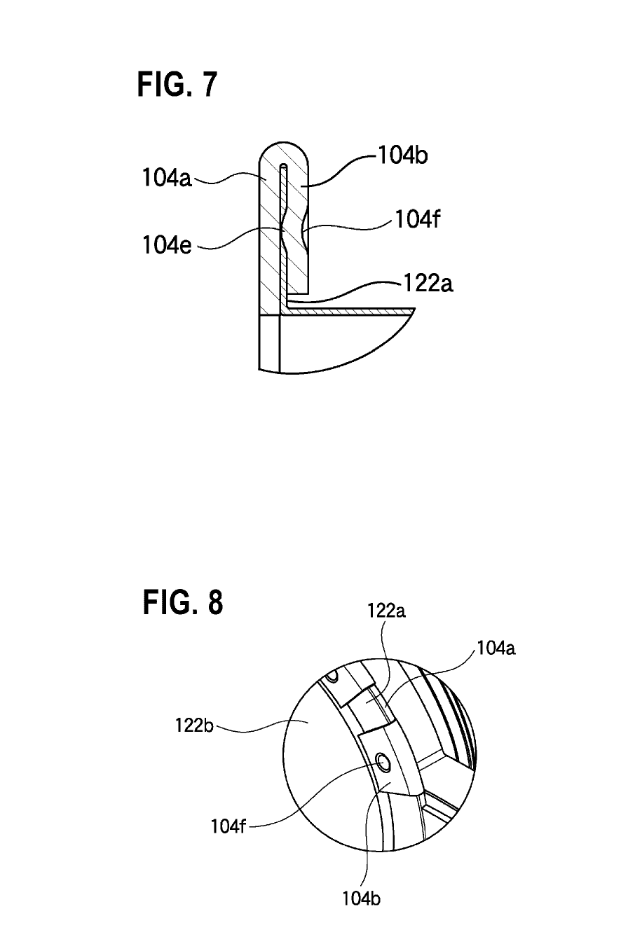

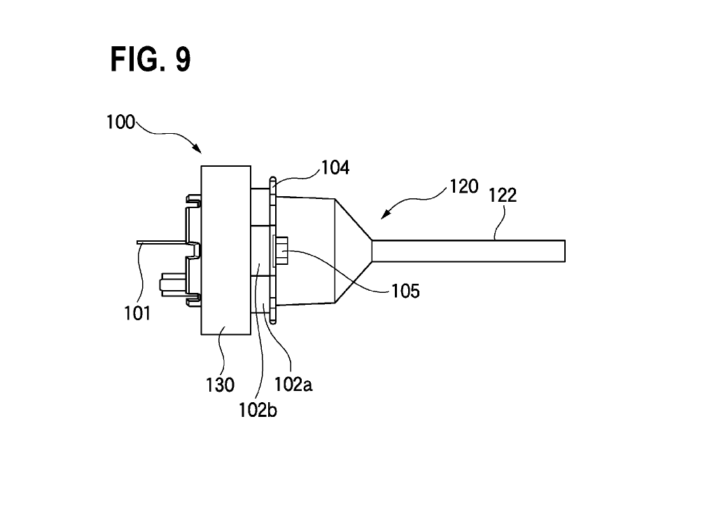

FIG. 1 is an exploded perspective view of a shield connector with electric wire and a device side case of the first embodiment of the present invention. FIG. 2 is a perspective view in which the shield connector with electric wire of the first embodiment of the present invention is attached to the device side case. FIGS. 3A to 3C are figures to describe the shape of a shield shell of the first embodiment of the present invention, in which FIG. 3A is a front view, FIG. 3B is an A-A line sectional view of FIG. 3A, and FIG. 3C is a perspective view. FIGS. 4A to 4C are figures to describe the shape of a braiding of the first embodiment of the present invention, in which FIG. 4A is a front view, FIG. 4B is a B-B line sectional view of FIG. 4A, and FIG. 4C is a perspective view. FIGS. 5A to 5D are figures to describe an operation of attaching the braiding to the shield shell of the first embodiment of the present invention, in which FIGS. 5A to 5D are sectional views to respectively describe one step of the operation. FIGS. 6A and 6B are perspective views of the shield connector with electric wire of the first embodiment of the present invention, in which FIG. 6A is a perspective view watched from the front side of the shield connector with electric wire, and FIG. 6B is a perspective view watched from the rear side of the shield connector with electric wire. FIG. 7 is an enlarged sectional view of a main part (shell tightening piece) in the shield shell of the first embodiment of the present invention. FIG. 8 is an enlarged figure of a C part of FIG. 6B. FIG. 9 is a side view in which the shield connector with electric wire of the first embodiment of the present invention is attached to the device side case.

[Constitution of Each Member of the First Embodiment]

A shield connector with electric wire of the first embodiment of the present invention includes a shield connector 100 and a shield electric wire 120, as shown in FIG. 1. Various electronic devices such as an inverter or a motor are loaded in an electric automobile or a hybrid automobile, and when the shield connector 100 is inserted into an insertion hole 131 which a housing (hereinafter referred to as device side case) 130 of the electronic device is provided with, the electronic device and the shield electric wire 120 are connected. The constitution of the shield connector 100 is described in detail as follows.

The shield connector 100 includes male terminals 101, a housing 102, a rear holder 103, a shield shell 104 and bolts 105, as shown in FIGS. 1, 2, 6A and 6B.

The male terminal 101 is a metal member, and one end of the male terminal 101 is formed into a plate shape. The one end of the male terminal 101 is fitted into a female terminal (not shown) at the electronic device side when the shield connector 100 is inserted into the insertion hole 131 which the device side case 130 is provided with. On the other hand, the other end of the male terminal 101 is joined to an electric wire 121 of the shield electric wire 120 by various methods such as laser joining or supersonic wave joining. Thereby, the electronic device and the electric wires 121 are connected through the male terminals 101.

The housing 102 is a member which is molded by using resin material. The housing 102 includes a housing body 102a in which a terminal accommodating room, which accommodates the male terminals 101, is formed to hold the male terminals 101, two flanges 102b which are provided at the outer periphery of the housing body 102a, and a rear holder accommodating part 102c which is provided adjacently to the housing body 102a, and in which a rear holder accommodating room which is communicated with the terminal accommodating room of the housing body 102a is formed.

The housing body 102a is formed into a cylindrical shape as a whole, as shown in FIGS. 1 and 6A. The terminal accommodating room to accommodate the male terminals 101 is formed to penetrate through the housing body 102a along the direction in which the male terminals 101 are inserted. The terminal accommodating room has intervals in the height direction and in the widthwise direction in the surface which is perpendicular to the direction in which the male terminals 101 are inserted, and the intervals are the same as the board thicknesses in the height direction and in the widthwise direction in the surface which is perpendicular to the longitudinal direction of the male terminals 101. Thereby, the male terminals 101 which are accommodated in the terminal accommodating room are held in the terminal accommodating room. The outer diameter of one part of the housing body 102a is slightly smaller than the inner diameter of the insertion hole 131 which the device side case 130 is provided with. Thereby, when the housing body 102a is inserted into the insertion hole 131, the housing body 102a is provisionally held in the insertion hole 131. The outer diameter of the other part of the housing body 102a is bigger than the inner diameter of the insertion hole 131. Thereby, when the housing body 102a is inserted into the insertion hole 131, the other part of the housing body 102a contacts the device side case 130, and the housing body 102a is regulated from being further inserted. Further, a circular waterproofing packing may be provided on the outer periphery of the housing body 102a, and when the housing body 102a is inserted into the insertion hole 131, the waterproofing packing prevents water that reaches the space between the housing body 102a and the insertion hole 131 from invading.

The two flanges 102b are provided to project from the outer periphery of the housing body 102a, as shown in FIGS. 1, 2, 6A and 6B. These flanges 102b are arranged at positions facing each other across the center of the housing body 102a. Particularly, in this first embodiment, these flanges 102b are arranged at positions facing each other along the direction in which the male terminals 101, which are held in the housing body 102a, line up. These flanges 102b are respectively formed with bolt holes 102e which penetrate through the flanges 102b in the board thickness direction. On the other hand, the device side case 130 is provided with two bolt holes 132 to sandwich the insertion hole 131. The distance between these two bolt holes 132 is the same as the distance between the two bolt holes 102e which the flanges 102b are respectively provided with. When the housing body 102a is inserted into the insertion hole 131, the housing body 102a is aligned so that the positions of the bolt holes 132 which the device side case 130 is provided with correspond to the positions of the bolt holes 102e which the flanges 102b are provided with, as shown in FIG. 2.

The rear holder accommodating part 102c has a rear holder accommodating room into which the rear holder 103 which has held the male terminals 101 is inserted. At this time, while the male terminals 101 penetrate through the rear holder accommodating room of the rear holder accommodating part 102c, and further penetrate through the terminal accommodating room of the housing body 102a, the male terminals 101 are held in the terminal accommodating room of the housing body 102a. The rear holder accommodating part 102c is provided with an engaging mechanism 102d which engages with the rear holder 103 which is accommodated in the rear holder accommodating room. Thereby, the rear holder 103 is maintained to be accommodated in the rear holder accommodating part 102c.

The rear holder 103 is a member molded by using resin material. The rear holder 103 is formed by assembling a pair of half bodies, and the outer periphery of the half bodies is covered by a rubber stopper. The half bodies of the rear holder 103 are formed with through holes, and the electric wires 121 joined to the male terminals 101, when inserted into the through holes, are held by the inner surfaces of the through holes. In this way, the electric wires 121 are fixed to the rear holder 103. The rear holder 103 to which the electric wires 121 are fixed in this way holds the male terminals 101 that extend to one side and holds the electric wires 121 that extend to the opposite side, as shown in FIG. 1. The rear holder 103 is provided with an engaging mechanism 103a which engages with the rear holder accommodating part 102c when the rear holder 103 enters the rear holder accommodating part 102c. When this engaging mechanism 103a engages with the engaging mechanism 102d which the rear holder accommodating part 102c is provided with, the rear holder 103 is maintained to be accommodated in the rear holder accommodating part 102c.

The shield shell 104 is a metal member, and, as shown in FIGS. 1 to 3C, is formed as a whole into a circular shape to which the leading end in the longitudinal direction of a shield member, which is formed into a hollow tubular shape, is attached. The shield shell 104 is made by processing, or punch-pressing and bend-pressing a plate-like metal plate. The shield shell 104 includes a discal shell main body 104a, a plurality of shell tightening pieces 104b which are extended from the outer edge of the shell main body 104a, and two flanges 104c which are extended from the outer edge of the shell main body 104a.

As shown in FIGS. 3A to 3C, the outer edge of the shell main body 104a is formed into a round shape. Inside the shell main body 104a, a through hole 104d is bored. The inner edge of the shell main body 104a defining the through hole 104d is also formed into a round shape. The inner edge (the through hole 104d) of the shell main body 104a and the outer edge of the shell main body 104a which both form round shapes in this way are formed so that their centers correspond to each other. Therefore, the width in the radial direction between the inner edge of the shell main body 104a and the outer edge of the shell main body 104a is a constant distance except the places where the flanges 104c are extended. The shape of the outer edge of the shell main body 104a substantially match the shape of the outer edge of the bottom surface (surface connected to the rear holder accommodating part 102c) of the housing body 102a, as shown in FIGS. 2, 6A and 6B. In this first embodiment, it is described that the inner edge of the shell main body 104a and the outer edge of the shell main body 104a have perfect round shapes, but the inner edge and the outer edge may have elliptical shapes.

The shell tightening pieces 104b, which are rectangular pieces that are punch-pressed to extend outward radially from the outer edge of the shell main body 104a, as shown in FIG. 5A, are bend-pressed to the shell main body 104a, as shown in FIGS. 4A to 4C and 5B. Before the leading end in the longitudinal direction of the shield member is attached to the shield shell 104, as shown in FIG. 5B, the shell tightening pieces 104b are bent so that an angle θ between a plane including the shell main body 104a and the direction in which the shell tightening pieces 104b are extended is an acute angle (however, 0<θ<90 degrees). On the other hand, after the leading end in the longitudinal direction of the shield member is attached to the shield shell 104, as shown in FIGS. 2, 7 and 8, the shell tightening pieces 104b are bent so that the shell main body 104a and the shell tightening pieces 104b are substantially in parallel with each other, or in other words, the above angle θ becomes substantially 0.

In this first embodiment, the shell main body 104a is provided with five shell tightening pieces 104b above and below a line binding the two flanges 104c, respectively. The five shell tightening pieces 104b above and below are respectively provided equidistantly along the outer edge of the shell main body 104a. Therefore, as shown in FIG. 3A, the shell tightening pieces 104b are respectively located across the center of the round shape that the outer edge of the shell main body 104a forms (that is, at positions symmetric relative to the center).

The two flanges 104c are formed by being punch-pressed to extend outward radially from the outer edge of the shell main body 104a, as shown in FIGS. 3A to 3C. These flanges 104c are respectively formed with bolt holes 104g which penetrate through the flanges 104c in the board thickness direction. The distance between the two bolt holes 104g which these flanges 104c are respectively provided with is the same as the distance between the two bolt holes 102e which the flanges 102b of the housing 102 are respectively provided with. When the shield shell 104 is attached to the housing 102, the shield shell 104 is aligned so that the positions of the two bolt holes 102e which the flanges 102b of the housing 102 are respectively provided with correspond to the positions of the two bolt holes 104g which the flanges 104c of the shield shell 104 are respectively provided with, as shown in FIG. 2.

The two bolts 105 are metal members, and engage threadedly into the bolt holes 132 which the device side case 130 is provided with. When the shield connector 100 is attached to the device side case 130, as shown in FIG. 1, while the bolts 105 penetrate through the bolt holes 104g which the flanges 104c of the shield shell 104 are provided with and penetrate through the bolt holes 102e which the flanges 102b of the housing 102 are provided with, the bolts 105 engage threadedly into the bolt holes 132 which the device side case 130 is provided with. By fastening the two bolts 105 in this way, as shown in FIG. 2, the shield shell 104 is fixed to the housing 102 and the housing 102 is fixed to the device side case 130.

Now, it is necessary for the shield shell 104 to be grounded to the GND of the electronic device. In realizing this grounding, since the whole device side case 130 is made of metal and the bolt holes 132 of the device side case 130 are made of metal, the device side case 130 or the bolt holes 132 are kept electrically connected to the GND of the electronic device. Thus, by engaging threadedly and fastening the bolts 105 to the bolt holes 132, the shield shell 104 and the device side case 130 or the bolt holes 132 are electrically connected through the bolts 105. In this way, the GNDs of the shield shell 104 and the electronic device can be commonized.

Then, the constitution of the shield electric wire 120 is described. The shield electric wire 120 includes the electric wires 121 and a braiding 122.

The electric wire 121 is constructed of a core wire and an insulative coating which covers the core wire. The electric wires 121 are assembled to the rear holder 103 while the core wires are joined to the male terminals 101. In this first embodiment, as shown in FIGS. 1 and 2, the shield electric wire 120 is arranged so that the two electric wires are adjacent to each other. When the electronic device to which the shield connector 100 is connected is a device in need of the supply of a relatively big electric current such as an inverter or a motor, the shapes of the core wires and the insulative coatings of the electric wires 121 are designed according to the current value appropriately.

The braiding 122 is formed into a hollow tubular shape by braiding strands having conductivity. The braiding 122 is a member equivalent to the shield member. The braiding 122 may be formed by braiding strands which are made, for example, by plating elastic fiber such as nylon. As shown in FIGS. 1 and 2, the braiding 122 is arranged around the two electric wires 121 to cover the two electric wires 121. The shield member of the present invention is not limited to a braiding. A conductive member (for example, a metal foil or the like) which is formed into a hollow tubular shape can be applied as the shield member of the present invention.

[Procedure of Attaching the Braiding to the Shield Shell and Shield Structure]

Next, a procedure of attaching the braiding 122 to the shield shell 104 and a shield structure in which the braiding 122 is attached to the shield shell 104 are described. At first, a procedure of attaching the braiding 122 to the shield shell 104 is described with reference to FIGS. 5A to 5C.

At first, before the braiding 122 is attached to the shield shell 104, it is necessary to prepare the shield shell 104 and the braiding 122 beforehand. The shield shell 104 which has the shell main body 104a, the shell tightening pieces 104b, the flanges 104c and the through hole 104d is formed into a plate shape by punch-pressing a metal plate, as shown in FIG. 5A. Right after the shield shell 104 is punch-pressed, the shell tightening pieces 104b are extended on a plane including the shell main body 104a.

After the punch-pressing, as shown in FIG. 5B, the shell tightening pieces 104b are bended to the shell main body 104a by being bend-pressed. At this time, the shell tightening pieces 104b are bent so that an angle θ between a plane including the shell main body 104a and the direction in which the shell tightening pieces 104b are extended is an acute angle (however, 0<θ<90 degrees). Using the shield shell 104 formed in this way, the following steps are carried out.

On the other hand, for the braiding 122, an end of the braiding 122 is processed to be widened toward one longitudinal end of the braiding 122, as shown in FIGS. 4A to 4C. Specifically, the diameter of the braiding 122 increases in an order of a small diameter part 122c which covers the two electric wires 121 at a position that is the nearest to the electric wires 121, a diameter enlarging part 122b which extends from the end of the small diameter part 122c and whose diameter is enlarged progressively from the small diameter part 122c, and a leading end 122a which extends from the end of the diameter enlarging part 122b on a plane which is perpendicular to the longitudinal direction of the braiding 122. The end, at the side of the leading end 122a, of the diameter enlarging part 122b is formed into a circular shape, and the diameter of the end is bigger than the diameter of the through hole 104d. Thereby, when the braiding 122 is attached to the shield shell 104, the end, at the side of the leading end 122a, of the diameter enlarging part 122b can accommodate the through hole 104d inside. In this first embodiment, the leading end 122a is expanded in the radial direction of the diameter enlarging part 122b from the whole periphery in the circumferential direction of the end of the diameter enlarging part 122b, but the leading end 122a may be developed from part of the periphery in the circumferential direction of the end of the diameter enlarging part 122b. More specifically, the leading end 122a may be provided to extend from the diameter enlarging part 122b in places corresponding to the shell tightening pieces 104b of the shield shell 104.

Using the shield shell 104 and the braiding 122 formed in this way, the braiding 122 is attached to the shield shell 104. At first, as shown in FIG. 5C, the braiding 122 is brought close toward the shield shell 104, and the leading end 122a of the braiding 122 is arranged between the shell main body 104a and all the shell tightening pieces 104b which make the angle θ. By arranging the leading end 122a in this way, the leading end 122a is arranged at the shell main body 104a to surround the through hole 104d.

Then, as shown in FIG. 5D, the shell tightening pieces 104b are further bend-pressed toward the shell main body 104a until the shell main body 104a and the shell tightening pieces 104b become substantially in parallel with each other. The shell tightening pieces 104b which are bent to the shell main body 104a in this way extend toward the center of the through hole 104d. Thereby, the leading end 122a is clamped by the shell main body 104a and the shell tightening pieces 104b In this way, the shield structure in which the braiding 122 is attached to the shield shell 104 is completed.

Here, before the leading end in the longitudinal direction of the braiding 122 is attached to the shield shell 104, by bending the shell tightening pieces 104b to form the angle θ with the shell main body 104a as shown in FIG. 5B, the following effect is obtained. When the braiding 122 is attached to the shield shell 104, the leading end 122a enters along the surface of the shell main body 104a toward the radial outside of the shell main body 104a. Then, the leading end 122a abuts against the bent shell tightening pieces 104b, and a further entry is regulated. In this way, the leading end 122a is positioned by the shell tightening pieces 104b. Since the leading end 122a is positioned by all the shell tightening pieces 104b, the leading end 122a can be arranged at the position conforming to the shape of the through hole 104d. As a result, arranging the leading end 122a to conform to the shape of the through hole 104d can be implemented by a simple operation. In this way, the operation of attaching the braiding 122 to the shield shell 104 can be performed efficiently. This effect is obtained when the angle θ is an acute angle, but when it is considered that the shell tightening pieces 104b are further bend-pressed toward the shell main body 104a in the step shown in FIG. 5D, it is preferable that the shell tightening pieces 104b are bent surely to the shell main body 104a by setting the angle θ to around 45 degrees.

In the shield structure in which the braiding 122 is attached to the shield shell 104 shown in FIG. 5D, the braiding 122 is grounded to the GND of the electronic device through the shield shell 104. In this way, for the shield structure of the present invention, a shielding function is implemented by the shield shell 104 and the braiding 122.

Now, in FIG. 5D, the structure in which the leading end 122a is clamped by the shell main body 104a and the shell tightening pieces 104b is described. In this first embodiment, to further raise the gripping force of the shell main body 104a and the shell tightening pieces 104b to grip the leading end 122a, a structure shown in FIG. 7 is adopted in the shell tightening pieces 104b. As shown in FIG. 7, the shell tightening pieces 104b are provided with protrusions 104e, on the surfaces which face the shell main body 104a when the shell tightening pieces 104b are bent to the shell main body 104a. With these protrusions 104e, when the shell tightening pieces 104b are bent until the shell tightening pieces 104b are substantially in parallel with the shell main body 104a, the leading end 122a is clamped by the shell main body 104a and the protrusions 104e by a big pressure force. Therefore, the leading end 122a is fixed to the shield shell 104 more strongly by the shell main body 104a and the shell tightening pieces 104b. Thus, the braiding 122 can be prevented from falling off from the shield shell 104. If the protrusions 104e enter the gaps between fibers in the braiding 122, even if an external force acts onto the braiding 122 in a direction of escaping from the shield shell 104, the braiding 122 is prevented from escaping from the shield shell 104 since the protrusions 104e are caught onto those fibers.

For example, the above protrusions 104e are formed at the time of bend-pressing shown in FIG. 5D by locally pushing surfaces opposite to the surfaces where the protrusions 104e are provided in the shell tightening pieces 104b. In this case, as shown in FIGS. 7 and 8, the shell tightening pieces 104b are formed with concaves 104f at positions corresponding to the protrusions 104e at surfaces opposite to the surfaces where the protrusions 104e are provided. Thus, by forming the protrusions 104e at the time of bend-pressing, the protrusions 104e can be easily formed at the shell tightening pieces 104b. If the protrusions 104e are formed by locally pushing the surfaces opposite to the surfaces where the protrusions 104e are formed, it becomes easy to adjust the projection height of the protrusions 104e which project from the shell tightening pieces 104b. The method to form the protrusions 104e is not limited to the above method. The protrusions 104e may be formed at the time of punch-pressing shown in FIG. 5A, and the protrusions 104e may be formed at desired places on the plate-like metal plate before pressing.

Then, the shield structure in which the braiding 122 is attached to the shield shell 104 as shown in FIG. 5D is attached to the housing 102 of the shield connector 100. As shown in FIGS. 6A and 6B, the shield structure of the present invention is attached to the housing 102, by making the two flanges 102b of the housing 102 and the two flanges 104c of the shield shell 104 opposed to each other. The shield connector with electric wire is completed in this way.

After this, as shown in FIGS. 2 and 9, the shield connector with electric wire is attached to the device side case 130. At this time, the shield connector with electric wire is aligned so that the housing body 102a is inserted into the insertion hole 131, and the positions of the bolt holes 132 which the device side case 130 is provided with correspond to the positions of the bolt holes 102e which the flanges 102b are provided with. While the bolts 105 penetrate through the bolt holes 104g which the flanges 104c of the shield shell 104 are provided with and the bolt holes 102e which the flanges 102b of the housing 102 are provided with, the bolts 105 engage threadedly into the bolt holes 132 which the device side case 130 is provided with. By fastening the two bolts 105 in this way, the shield shell 104 is fixed to the housing 102 and the housing 102 is fixed to the device side case 130.

[Effect of the First Embodiment]

According to the first embodiment of the present invention above, upon attaching the braiding 122 to the shield shell 104, a shield ring used traditionally becomes needless. Therefore, the component number of the shield connector 100 can be reduced. Even if the component number decreases in this way, a shielding function is maintained by the shield structure constructed of the shield shell 104 and the braiding 122. Thus, compared with a traditional shield connector, the component cost of the shield connector 100, whose component number decreases while the shielding function is maintained, can be reduced. As a result, the cost of a wire harness in which the shield connector is included as a component can be reduced.

The shield shell 104 adopted in the shield connector 100 has a shape which is molded only by punch-pressing and bend-pressing. Therefore, the manufacturing method can be simplified in comparison with a traditional manufacturing method of manufacturing a shield shell by twist-pressing or die-casting. Therefore, the manufacturing cost to manufacture the shield shell 104 can be reduced. As a result, the cost of a wire harness in which the shield connector is included as a component can be reduced.

In the first embodiment of the present invention, the shell tightening pieces 104b are provided equidistantly along the outer edge of the shell main body 104a. As a result of this construction, the shell main body 104a and the shell tightening pieces 104b can grip the leading end 122a of the braiding 122 equidistantly along the circumferential direction. Therefore, even if an external force acts onto the braiding 122 in a direction of escaping from the shield shell 104, an internal force to resist the external force acts uniformly onto the leading end 122a of the braiding 122 along the circumferential direction. Thereby, since the internal force locally acts on a part of the leading end 122a of the braiding 122, it can be prevented that the part of the braiding 122 is damaged.

In the first embodiment of the present invention, the shell tightening pieces 104b are provided with the protrusions 104e. As a result of this construction, the leading end 122a is clamped by the shell main body 104a and the protrusions 104e by a big pressure force. Therefore, the leading end 122a is fixed to the shield shell 104 more strongly by the shell main body 104a and the shell tightening pieces 104b. If the protrusions 104e enter the gaps between fibers in the braiding 122, even if an external force acts onto the braiding 122 in a direction of escaping from the shield shell 104, the protrusions 104e are caught onto those fibers. Thus, the braiding 122 can be prevented from escaping from the shield shell 104.

In the first embodiment of the present invention, the concaves 104f are formed at positions corresponding to the protrusions 104e at surfaces opposite to the surfaces where the protrusions 104e are provided. As a result of this construction, by forming the protrusions 104e at the time of bend-pressing, the protrusions 104e can be easily formed at the shell tightening pieces 104b. Further, it becomes easy to adjust the projection height of the protrusions 104e which project from the shell tightening pieces 104b.

In the first embodiment of the present invention, the shell tightening pieces 104b which are bent to the shell main body 104a extend toward the center of the through hole 104d. As a result of this construction, a range that is wider than the leading end 122a of the braiding 122 can be gripped by the shell main body 104a and the shell tightening pieces 104b. Therefore, the leading end 122a can be fixed to the shield shell 104 more strongly.

In the first embodiment of the present invention, the inner edge (the through hole 104d) of the shell main body 104a and the outer edge of the shell main body 104a are formed so that their centers match. As a result of this construction, the braiding 122 can be attached to the center of the shell main body 104a. Thereby, the shell tightening pieces 104b can be formed into the same shape and the shape of the shield shell 104 can be formed more simply. The present invention also includes that the braiding 122 is attached at a position eccentric from the center of the shell main body 104a. Even if the braiding 122 is attached at the position eccentric from the center of the shell main body 104a, by designing the extended length of the shell tightening pieces 104b appropriately, the braiding 122 can be attached to the shield shell 104.

In the first embodiment of the present invention, it is described that the shield structure of the present invention is applied to the shield connector 100, but the present invention is not limited to this. It is also possible that upon connecting the leading end of the shield electric wire 120 to the electronic device, while the electric wires 121 pass the through hole 104d, the shield shell 104 to which the braiding 122 is attached is directly fixed to the device side case 130, and the device side case 130 and the shield shell 104 are electrically connected.

Subsequently, the second embodiment of the present invention is described.

### Second Embodiment

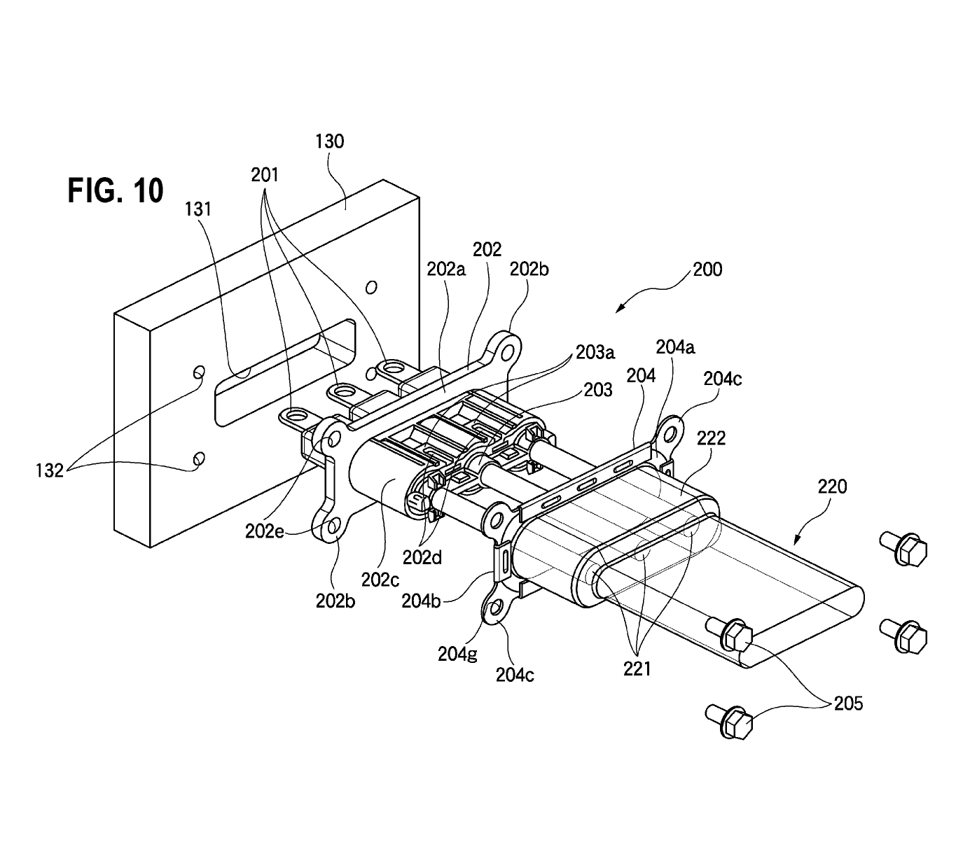

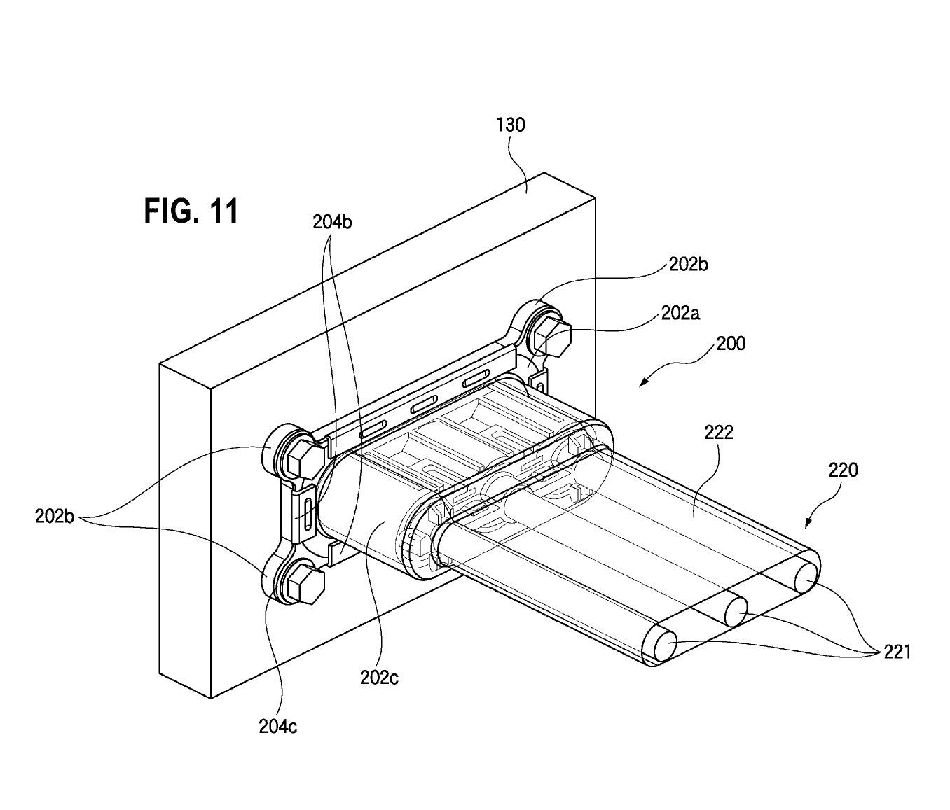

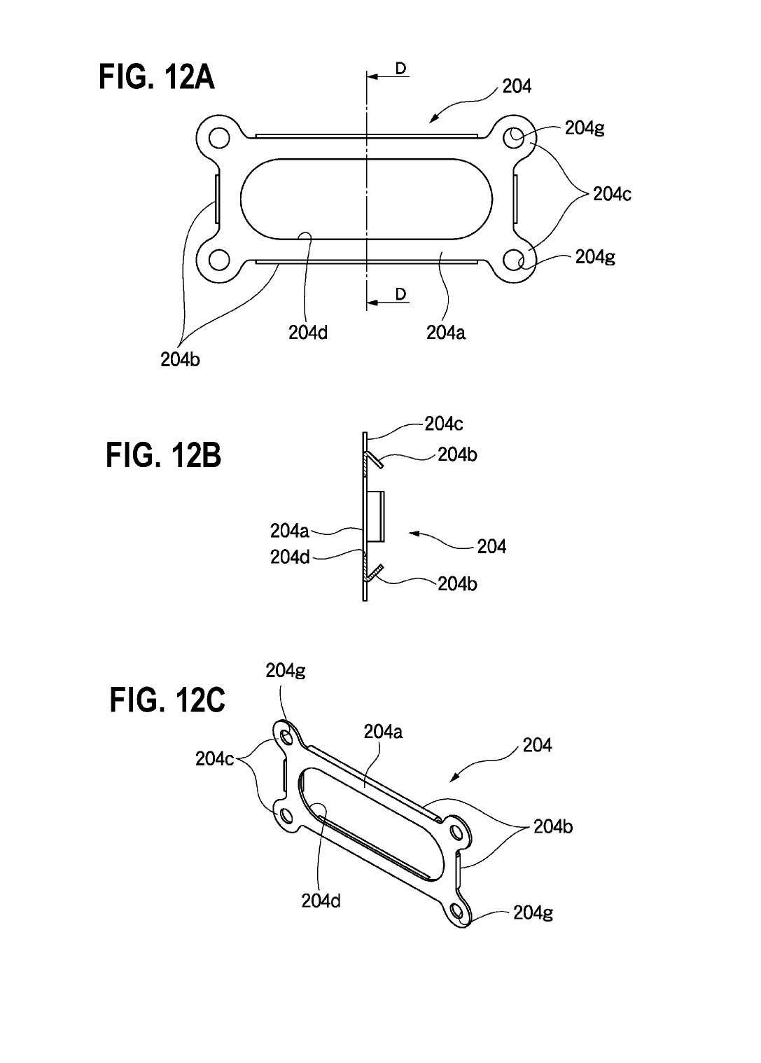

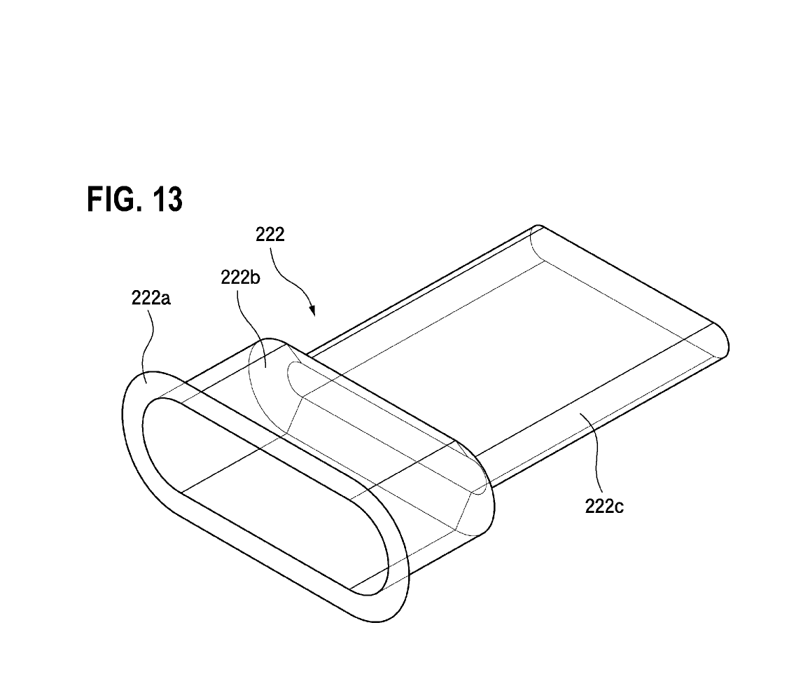

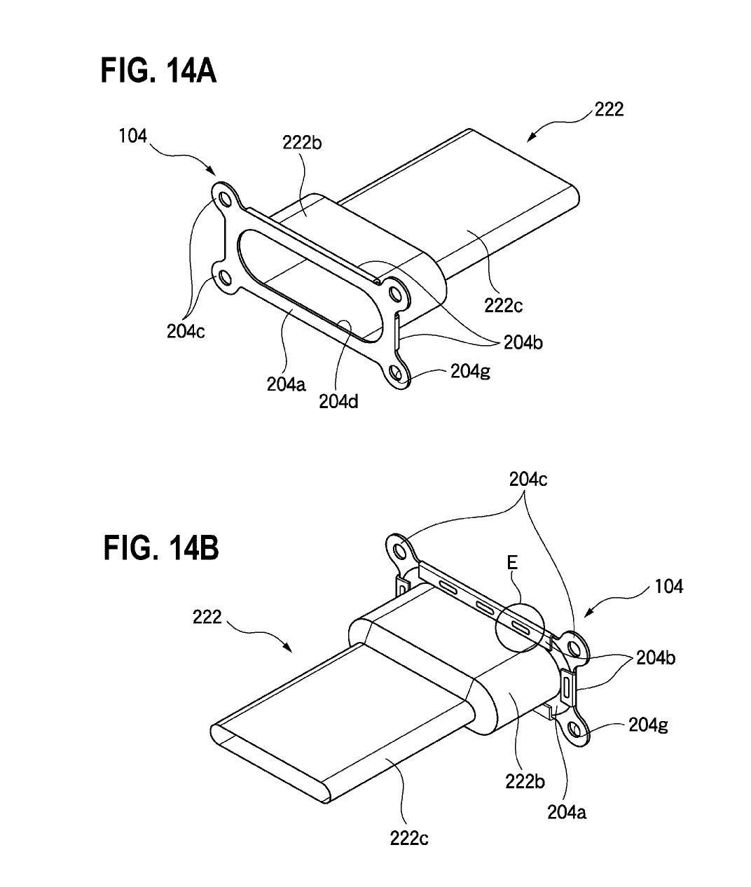

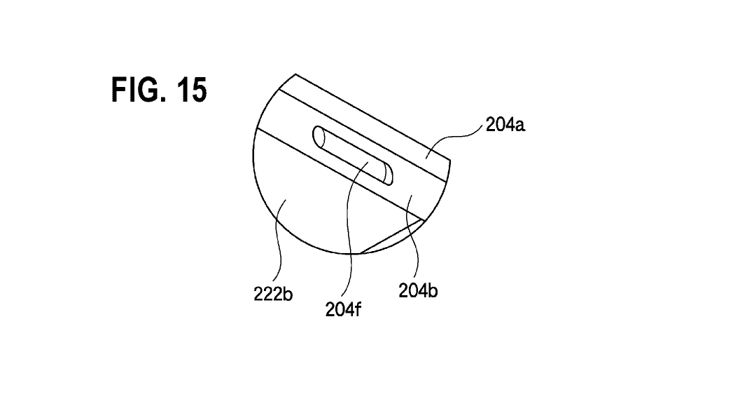

FIG. 10 is an exploded perspective view of a shield connector with electric wire and a device side case of the second embodiment of the present invention. FIG. 11 is a perspective view in which the shield connector with electric wire of the second embodiment of the present invention is attached to the device side case. FIGS. 12A to 12C are figures to describe the shape of a shield shell of the second embodiment of the present invention, in which FIG. 12A is a front view, FIG. 12B is a D-D line sectional view of FIG. 12A, and FIG. 12C is a perspective view. FIG. 13 is a perspective view to describe the shape of a braiding of the second embodiment of the present invention. FIGS. 14A and 14B are perspective views to describe a shield structure of the second embodiment the present invention, in which FIG. 14A is a perspective view watched from the front side of the shield structure, and FIG. 14B is a perspective view watched from the rear side of the shield structure. FIG. 15 is an enlarged figure of an E part of FIG. 14B.

[Constitution of Each Member of the Second Embodiment]

A shield connector with electric wire of the second embodiment of the present invention includes a shield connector 200 and a shield electric wire 220, as shown in FIG. 10. The function of the shield connector 200 is similar to that of the shield connector 100 described in the first embodiment. The constitution of the shield connector 200 is described in detail as follows.

The shield connector 200 includes male terminals 201, a housing 202, a rear holder 203, a shield shell 204 and bolts 205, as shown in FIGS. 10 and 11.

The male terminals 201 are the same members as the male terminals 101 described in the first embodiment. An electronic device and electric wires 221 are connected through the male terminals 201.

The housing 202 is different in shape from the housing 102 described in the first embodiment, but is a member having a similar function. The housing 202 is a member which is molded by using resin material. The housing 202 includes a housing body 202a in which a terminal accommodating room, which accommodates the male terminals 201, is formed to hold the male terminals 201, four flanges 202b which are provided at the outer periphery of the housing body 202a, and a rear holder accommodating part 202c which is provided adjacently to the housing body 202a, and in which a rear holder accommodating room which is communicated with the terminal accommodating room of the housing body 202a is formed.

The housing body 202a is formed into a cuboid shape as a whole, as shown in FIGS. 10 and 11. The terminal accommodating room to accommodate the male terminals 201 is formed to penetrate through the housing body 202a along the direction in which the male terminals 201 are inserted. The terminal accommodating room has intervals in the height direction and in the widthwise direction in the surface which is perpendicular to the direction in which the male terminals 201 are inserted, and the intervals are the same as the board thicknesses in the height direction and in the widthwise direction in the surface which is perpendicular to the longitudinal direction of the male terminals 201. Thereby, the male terminals 201 which are accommodated in the terminal accommodating room are held in the terminal accommodating room. The outer diameter of one part of the housing body 202a is slightly smaller than the inner diameter of an insertion hole 131 which a device side case 130 is provided with. Thereby, when the housing body 202a is inserted into the insertion hole 131, the housing body 202a is provisionally held in the insertion hole 131. The outer diameter of the other part of the housing body 202a is bigger than the inner diameter of the insertion hole 131. Thereby, when the housing body 202a is inserted into the insertion hole 131, the other part of the housing body 202a contacts the device side case 130, and the housing body 102a is regulated from being further inserted.

The four flanges 202b are provided to project from the outer periphery of the housing body 202a, as shown in FIGS. 10 and 11. These flanges 202b are arranged at positions facing each other across the center of the housing body 202a. Particularly, in this second embodiment, two of these flanges 202b are arranged to line up at positions respectively above and below the male terminals 201 which are held in the housing body 202a. These flanges 202b are respectively formed with bolt holes 202e which penetrate through the flanges 202b in the board thickness direction. On the other hand, the device side case 130 is provided with four bolt holes 132 to sandwich the insertion hole 131. These four bolt holes 132 are formed at positions corresponding to the four bolt holes 202e which the flanges 202b are respectively provided with. When the housing body 202a is inserted into the insertion hole 131, the housing body 202a is aligned so that the positions of the bolt holes 132 which the device side case 130 is provided with correspond to the positions of the bolt holes 202e which the flanges 202b are provided with, as shown in FIG. 2.

The rear holder accommodating part 202c has a rear holder accommodating room into which the rear holder 203 which has held the male terminals 201 is inserted. At this time, while the male terminals 201 penetrate through the rear holder accommodating room of the rear holder accommodating part 202c, and further penetrate through the terminal accommodating room of the housing body 202a, the male terminals 101 are held in the terminal accommodating room of the housing body 202a. The rear holder accommodating part 202c is provided with an engaging mechanism 202d which engages with the rear holder 203 which is accommodated in the rear holder accommodating room. Thereby, the rear holder 203 is maintained to be accommodated in the rear holder accommodating part 202c.

The rear holder 203 is different in shape from the rear holder 103 described in the first embodiment, but is a member having a similar function. The rear holder 203 is a member which is molded by using resin material. The electric wires 221 joined to the male terminals 201, when inserted into through holes, are held by the inner surfaces of the through holes. In this way, the electric wires 121 are fixed to the rear holder 103. The rear holder 203 to which the electric wires 121 are fixed in this way holds the male terminals 201 that extend to one side and holds the electric wires 221 that extend to the opposite side, as shown in FIG. 10. The rear holder 203 is provided with an engaging mechanism 203a which engages with the rear holder accommodating part 202c when the rear holder 203 enters the rear holder accommodating part 202c. When this engaging mechanism 203a engages with the engaging mechanism 202d which the rear holder accommodating part 202c is provided with, the rear holder 203 is maintained to be accommodated in the rear holder accommodating part 202c.

The shield shell 204 is a metal member, and, as shown in FIGS. 10 to 12C, is formed as a whole into a circular shape to which the leading end in the longitudinal direction of a braiding, which is formed into a hollow tubular shape, is attached. The shield shell 204 is made by processing, or punch-pressing and bend-pressing a plate-like metal plate. The shield shell 204 includes a rectangular shell main body 204a, a plurality of shell tightening pieces 204b which are extended from the outer edge of the shell main body 204a, and four flanges 204c which are extended from the outer edge of the shell main body 204a.

As shown in FIGS. 12A to 12C, the outer edge of the shell main body 204a is formed into a rectangular shape. Inside the shell main body 204a, a through hole 204d is bored. The inner edge of the shell main body 204a defining the through hole 204d is formed into a rectangular shape whose four corners are rounded. The shape of the outer edge of the shell main body 204a and the shape of the inner edge of the shell main body 204a are similar to each other. The inner edge (the through hole 204d) of the shell main body 204a and the outer edge of the shell main body 204a which both form rectangular shapes in this way are formed so that their centers correspond to each other. Therefore, the vertical and horizontal widths between the inner edge of the shell main body 204a and the outer edge of the shell main body 204a are a constant distance except the places where the flanges 204c are extended. The shape of the outer edge of the shell main body 204a substantially match the shape of the outer edge of the bottom surface (surface connected to the rear holder accommodating part 202c) of the housing body 202a, as shown in FIG. 11. In this second embodiment, it is described that the inner edge of the shell main body 204a and the outer edge of the shell main body 204a have rectangular shapes, but the inner edge and the outer edge are not limited to the rectangular shapes, and it is possible to apply any polygonal shapes. The four corners of the inner edge of the shell main body 204a are rounded, but the shape of the corners can be changed appropriately depending on the shape of the rear holder accommodating part 202c.

As shown in FIGS. 12A to 12C, the shell tightening pieces 204b, which are rectangular pieces that are punch-pressed to extend outward from the outer edge of the shell main body 204a, are bend-pressed to the shell main body 204a. Before the leading end in the longitudinal direction of the braiding 222 is attached to the shield shell 204, as shown in FIG. 12B, the shell tightening pieces 204b, like the shell tightening pieces 104b of the first embodiment, are bent so that an angle θ between a plane including the shell main body 204a and the direction in which the shell tightening pieces 204b are extended is an acute angle (however, 0<θ<90 degrees). On the other hand, after the leading end in the longitudinal direction of the braiding 222 is attached to the shield shell 204, as shown in FIGS. 10, 11 and 14B, the shell tightening pieces 204b are bent so that the shell main body 204a and the shell tightening pieces 204b are substantially in parallel with each other, or in other words, the above angle θ becomes substantially 0.

In this second embodiment, the four sides of the rectangular shell main body 204a are respectively provided with the shell tightening pieces 204b. The top and bottom shell tightening pieces 204b which are opposed to each other have the same shape, and the right and left shell tightening pieces 204b which are opposed to each other also have the same shape. Therefore, the shell tightening pieces 204b exist respectively at positions which are symmetrical vertically and horizontally, as shown in FIGS. 12A to 12C.

The four flanges 204c are formed by being punch-pressed to extend outward from the corners of the outer edge of the shell main body 204a, as shown in FIGS. 12A to 12C. These flanges 204c are respectively formed with bolt holes 204g which penetrate through the flanges 204c in the board thickness direction. The bolt holes 204g which these flanges 204c are respectively provided with are provided at positions corresponding to the bolt holes 202e which these flanges 202b of the housing 202 are respectively provided with. When the shield shell 204 is attached to the housing 202, the shield shell 204 is aligned so that the positions of the bolt holes 202e which the flanges 202b of the housing 202 are respectively provided with correspond to the positions of the bolt holes 204g which the flanges 204c of the shield shell 204 are respectively provided with, as shown in FIG. 11.

Each of the four bolts 205 is the same member as the bolt 105 described in the first embodiment. By fastening the four bolts 205, as shown in FIG. 11, the shield shell 204 is fixed to the housing 202 and the housing 202 is fixed to the device side case 130.

Then, the constitution of the shield electric wire 220 is described. The shield electric wire 220 includes the electric wires 221 and a braiding 222.

The electric wires 221 are members similar to the electric wires 121 described in the first embodiment.

The braiding 222 is a member similar to the braiding 122 described in the first embodiment. As shown in FIGS. 10 and 11, the braiding 222 is arranged around three electric wires 121 to cover the three electric wires 121.

[Procedure of Attaching the Braiding to the Shield Shell and Shield Structure]

Next, a procedure of attaching the braiding 222 to the shield shell 204 and a shield structure in which the braiding 222 is attached to the shield shell 204 are described.

At first, before the braiding 222 is attached to the shield shell 204, it is necessary to prepare the shield shell 204 and the braiding 222 beforehand. The shield shell 204, like the shield shell 104 of the first embodiment, which has the shell main body 204a, the shell tightening pieces 204b, the flanges 204c and the through hole 204d, is formed into a plate shape by punch-pressing a metal plate. Right after the shield shell 204 is punch-pressed, the shell tightening pieces 204b are extended on a plane including the shell main body 204a.

After the punch-pressing, as shown in FIG. 12B, the shell tightening pieces 204b are bended to the shell main body 204a by being bend-pressed. At this time, the shell tightening pieces 204b are bent so that an angle θ between a plane including the shell main body 204a and the direction in which the shell tightening pieces 104b are extended is an acute angle (however, 0<θ<90 degrees). Using the shield shell 204 formed in this way, the following steps are carried out.

On the other hand, for the braiding 222, an end of the braiding 222 is processed to be widened toward one longitudinal end of the braiding 222, as shown in FIG. 13. Specifically, the diameter of the braiding 222 increases in an order of a small diameter part 222c which covers the three electric wires 221 at a position that is the nearest to the electric wires 221, a diameter enlarging part 222b which extends from the end of the small diameter part 222c and whose diameter is enlarged progressively from the small diameter part 222c, and a leading end 222a which extends from the end of the diameter enlarging part 222b on a plane which is perpendicular to the longitudinal direction of the braiding 222. The end, at the side of the leading end 222a, of the diameter enlarging part 222b is formed into a rectangular shape whose four corners are rounded, and the size of the end is bigger than the diameter of the through hole 204d. Thereby, when the braiding 222 is attached to the shield shell 204, the end, at the side of the leading end 222a, of the diameter enlarging part 222b can accommodate the through hole 204d inside. In this second embodiment, the leading end 222a is expanded in the radial direction of the diameter enlarging part 222b from the whole periphery in the circumferential direction of the end of the diameter enlarging part 222b, but the leading end 222a may be developed from part of the periphery in the circumferential direction of the end of the diameter enlarging part 222b. More specifically, the leading end 222a may be provided to extend from the diameter enlarging part 222b in places corresponding to the shell tightening pieces 204b of the shield shell 204.

Using the shield shell 204 and the braiding 222 formed in this way, the braiding 222 is attached to the shield shell 204. The attaching method is similar to the method described with reference to FIGS. 5C and 5D in the first embodiment. At first, the braiding 222 is brought close toward the shield shell 204, and the leading end 222a of the braiding 222 is arranged between the shell main body 204a and all the shell tightening pieces 204b which make the angle θ. By arranging the leading end 222a in this way, the leading end 222a is arranged at the shell main body 204a to surround the through hole 204d.

Then, the shell tightening pieces 204b are further bend-pressed toward the shell main body 204a until the shell main body 204a and the shell tightening pieces 204b become substantially in parallel with each other. The shell tightening pieces 204b which are bent to the shell main body 204a in this way extend toward the center of the through hole 204d. Thereby, the leading end 222a is clamped by the shell main body 204a and the shell tightening pieces 204b. In this way, the shield structure in which the braiding 222 is attached to the shield shell 204 is completed.

In this second embodiment, like the first embodiment, the shell tightening pieces 204b may also be provided with protrusions (equivalent to the protrusions 104e of the first embodiment.) on the surfaces which face the shell main body 104a when the shell tightening pieces 204b are bent toward the shell main body 104a. Thereby, the gripping force by which the leading end 222a is gripped by the shell main body 204a and the shell tightening pieces 204b can be further raised. If the protrusions enter the gaps between fibers in the braiding 222, even if an external force acts onto the braiding 222 in a direction of escaping from the shield shell 204, the braiding 222 is prevented from escaping from the shield shell 204 since the protrusions are caught onto those fibers. In this case, for example, the above protrusions are formed at the time of bend-pressing by locally pushing surfaces opposite to the surfaces where the protrusions are provided in the shell tightening pieces 204b. In this case, as shown in FIGS. 14B and 15, the shell tightening pieces 204b are formed with concaves 204f at positions corresponding to the protrusions at surfaces opposite to the surfaces where the protrusions are provided. Thus, by forming the protrusions at the time of bend-pressing, the protrusions can be easily formed at the shell tightening pieces 204b. If the protrusions are formed by locally pushing the surfaces opposite to the surfaces where the protrusions are formed, it becomes easy to adjust the projection height of the protrusions 104e which project from the shell tightening pieces 204b.

Then, the shield structure in which the braiding 222 is attached to the shield shell 204 as shown in FIGS. 14A and 14B is attached to the housing 202 of the shield connector 200. The shield structure of the present invention is attached to the housing 202, by making the four flanges 202b of the housing 202 and the four flanges 204c of the shield shell 204 opposed to each other. The shield connector with electric wire is completed in this way.

After this, as shown in FIG. 11, the shield connector with electric wire is attached to the device side case 130. At this time, the shield connector with electric wire is aligned so that the housing body 202a is inserted into the insertion hole 131, and the positions of the bolt holes 132 which the device side case 130 is provided with correspond to the positions of the bolt holes 202e which the flanges 202b are provided with. While the bolts 205 penetrate through the bolt holes 204g which the flanges 204c of the shield shell 204 are provided with and the bolt holes 202e which the flanges 202b of the housing 202 are provided with, the bolts 105 engage threadedly into the bolt holes 132 which the device side case 130 is provided with. By fastening the four bolts 205 in this way, the shield shell 204 is fixed to the housing 202 and the housing 202 is fixed to the device side case 130.

[Effect of the Second Embodiment]

According to the second embodiment of the present invention above, upon attaching the braiding 222 to the shield shell 204, a shield ring used traditionally becomes needless. Therefore, the component number of the shield connector 200 can be reduced. Even if the component number decreases in this way, a shielding function is maintained by the shield structure constructed of the shield shell 204 and the braiding 222. Thus, compared with a traditional shield connector, the component cost of the shield connector 200, whose component number decreases while the shielding function is maintained, can be reduced. As a result, the cost of a wire harness in which the shield connector is included as a component can be reduced.

The shield shell 204 adopted in the shield connector 200 has a shape which is molded only by punch-pressing and bend-pressing. Therefore, the manufacturing method can be simplified in comparison with a traditional manufacturing method of manufacturing a shield shell by twist-pressing or die-casting. Therefore, the manufacturing cost to manufacture the shield shell 204 can be reduced. As a result, the cost of a wire harness in which the shield connector is included as a component can be reduced.

In the second embodiment of the present invention, the shell tightening pieces 204b which are bent to the shell main body 204a extend toward the center of the through hole 204d. As a result of this construction, a range that is wider than the leading end 222a of the braiding 222 can be gripped by the shell main body 204a and the shell tightening pieces 204b. Therefore, the leading end 222a can be fixed to the shield shell 204 more strongly.

In the second embodiment of the present invention, the inner edge (the through hole 204d) of the shell main body 204a and the outer edge of the shell main body 204a are formed so that their centers match. As a result of this construction, the braiding 222 can be attached to the center of the shell main body 204a. Thereby, the length by which the shell tightening pieces 204b are extended from the shell main body 204a can be made uniform, and the shape of the shield shell 204 can be formed more simply. The present invention also includes that the braiding 222 is attached at a position eccentric from the center of the shell main body 204a. Even if the braiding 222 is attached at the position eccentric from the center of the shell main body 204a, by designing the extended length of the shell tightening pieces 204b appropriately, the braiding 222 can be attached to the shield shell 204.

In the second embodiment of the present invention, it is described that the shield structure of the present invention is applied to the shield connector 200, but the present invention is not limited to this. It is also possible that upon connecting the leading end of the shield electric wire 220 to the electronic device, while the electric wires 221 pass the through hole 204d, a shield shell 240 to which the braiding 222 is attached is directly fixed to a device side case 230, and the device side case 130 and the shield shell 240 are electrically connected.

The features of the embodiments of the shield structure, the shield shell and the method of manufacturing the shield connector with electric wire according to the present invention described above are briefly, collectively listed in the following [1] to [10], respectively.

[1] A shield structure, including

a shield member (braiding 122, 222) which is formed into a hollow tubular shape, and a shield shell (104, 204) to which the leading end in the longitudinal direction of the shield member is attached, wherein

the shield shell has a plate-like shell main body (104a, 204a) through which a through hole (104d, 204d) is bored, and a plurality of shell tightening pieces (104b, 204b) which are extended from the outer edge of the shell main body, the shell main body is so arranged that the leading end (122a, 222a) in the longitudinal direction of the shield member surrounds the through hole, and the leading end in the longitudinal direction of the shield member is clamped by the shell main body and the shell tightening pieces which are bent to the shell main body.

[2] The shield structure according to [1], wherein

the shell tightening pieces are provided equidistantly along the outer edge of the shell main body.

[3] The shield structure according to [1] or [2], wherein the shell tightening pieces are provided with protrusions (104e) on surfaces which face the shell main body when the shell tightening pieces are bent to the shell main body.

[4] The shield structure according to [3], wherein

the shell tightening pieces are formed with concaves (104f) at positions corresponding to the protrusions on surfaces opposite to the surfaces where the protrusions are provided.

[5] The shield structure according to any one of [1] to [4], wherein

the shell tightening pieces which are bent to the shell main body extend toward the center of the through hole.

[6] The shield structure according to any one of [1] to [5], wherein

the shape of the through hole of the shell main body and the shape that defines the outer edge of the shell main body are round, and the center of the through hole corresponds to the center of the shape of the outer edge of the shell main body.

[7] The shield structure according to any one of [1] to [5], wherein

the shape of the through hole of the shell main body and the shape that defines the outer edge of the shell main body are rectangles that are similar to each other, and the center of the through hole corresponds to the center of the shape of the outer edge of the shell main body.

[8]A shield shell, including

a plate-like shell main body through which a through hole is bored, and

a plurality of shell tightening pieces which are extended from the outer edge of the shell main body, wherein

the leading end in the longitudinal direction of a shield member which is arranged to surround the through hole may be clamped by the shell main body and the shell tightening pieces which are bent to the shell main body.

[9] The shield shell according to [8], wherein

an angle between a plane including the shell main body and a direction in which the shell tightening pieces are extended is an acute angle.

[10]A method of manufacturing a shield connector with electric wire, including

a pressing step of forming a shield shell which has a plate-like shell main body through which a through hole is bored, and a plurality of shell tightening pieces which are extended from the outer edge of the shell main body by pressing a metal plate, an arranging step of arranging the leading end in the longitudinal direction of a shield member which is formed into a hollow tubular shape to the shell main body to surround the through hole, and a bending step of clamping the leading end in the longitudinal direction of the shield member with the shell main body and the shell tightening pieces by bending the shell tightening pieces to the shell main body.

Although the invention is described in detail with reference to the specific embodiments, it is apparent that various modifications and amendments may be made by those skilled in the art without departing from the spirit and scope of the invention.

According to the present invention, effects are achieved that the component number of the shield connector is reduced and the shield connector with electric wire can be manufactured by a simpler manufacturing method. The present invention that achieves the above effects is useful in the structure of a shield shell.

What is claimed is:

1. A shield structure, comprising:
a shield member which is formed into a hollow tubular shape; and
a shield shell to which a leading end in the longitudinal direction of the shield member is attached,
wherein the shield shell has a plate-like shell main body through which a through hole is bored, and a plurality of shell tightening pieces which are extended from an outer edge of the shell main body,
the shell main body is so arranged that the leading end in the longitudinal direction of the shield member surrounds the through hole, and
the leading end in the longitudinal direction of the shield member is clamped by the shell main body and the shell tightening pieces which are bent to the shell main body.

2. The shield structure according to claim 1, wherein the shell tightening pieces are provided equidistantly along the outer edge of the shell main body.

3. The shield structure according to claim 1, wherein the shell tightening pieces are provided with protrusions on surfaces which face the shell main body when the shell tightening pieces are bent to the shell main body.

4. The shield structure according to claim 3, wherein the shell tightening pieces are formed with concaves at positions corresponding to the protrusions on surfaces opposite to the surfaces where the protrusions are provided.

5. A shield shell comprising:
a plate-like shell main body through which a through hole is bored; and
a plurality of shell tightening pieces which are extended from an outer edge of the shell main body,
wherein a leading end in the longitudinal direction of a shield member which is arranged to surround the through hole may be clamped by the shell main body and the shell tightening pieces which are bent to the shell main body.

6. A method of manufacturing a shield connector with electric wire comprising:
a pressing step of forming a shield shell which has a plate-like shell main body through which a through hole is bored, and a plurality of shell tightening pieces which are extended from an outer edge of the shell main body, by pressing a metal plate;
an arranging step of arranging a leading end in the longitudinal direction of a shield member which is formed into a hollow tubular shape to the shell main body to surround the through hole; and
a bending step of clamping the leading end in the longitudinal direction of the shield member with the shell main body and the shell tightening pieces by bending the shell tightening pieces to the shell main body.
